(19) United States
(12) Patent Application Publication
(10) Pub. No.: US 2015/0061599 A1
(43) Pub. Date: Mar. 5, 2015

(54) PORTABLE ELECTRONIC APPARATUS

(71) Applicant: SAMSUNG SDI CO., LTD., Yongin-si (KR)

(72) Inventors: Jeong-Seop LEE, Suwon-si (KR); Seok-Gyun CHANG, Suwon-si (KR); Eun-Joo KWAK, Suwon-si (KR); Myung-Sook KWON, Suwon-si (KR); Hyo-Bin BANG, Suwon-si (KR)

(21) Appl. No.: 14/468,606

(22) Filed: Aug. 26, 2014

(30) Foreign Application Priority Data
Aug. 28, 2013 (KR) 10-2013-0102116

(51) Int. Cl. H02J 7/00

(52) U.S. Cl. CPC H02J 7/0045; H02J 7/0063
USPC 320/127

(57) ABSTRACT

A portable electronic apparatus includes a terminal, a grip portion and a controller. A first battery is provided inside the terminal. The grip portion is positioned outside of the terminal and includes a second battery unit electrically connected to the terminal. The controller controls the second battery unit to supply power to the terminal before power of the first battery unit is supplied to the terminal. Accordingly, the controller first supplies the power of the second battery unit to the terminal rather than the power of the first battery unit.

### CROSS-REFERENCE TO RELATED APPLICATION

Korean Patent Application No. 10-2013-0102116, filed on Aug. 28, 2013, in the Korean Intellectual Property Office, and entitled: “Portable Electronic Apparatus,” is incorporated by reference herein in its entirety.

### BACKGROUND

1. Field

Embodiments relate to a portable electronic apparatus.

2. Description of the Related Art

As technologies are gradually developed, various kinds of electronic components are integrated and miniaturized. Accordingly, many compact portable electronic apparatuses which can be carried by a person have appeared. For example, the portable electronic apparatuses are a folder-type cellular phone, a bar-type cellular phone, a slide-type cellular phone, an MP3 player, a CD player, a portable multimedia player (PMP), a personal digital assistant (PDA), a tablet computer, a portable compact TV, a portable game machine, a notebook computer, an electronic dictionary, a navigation device, a GPS receiver, and the like.

Recently, a portable electronic apparatus, such as a smart phone or tablet PC, in which functions of various portable electronic apparatuses are put together, have appeared. Accordingly, the price of the portable electronic apparatus is increased. However, since the portable electronic apparatus uses a larger number of functions and integrated circuits, much power is required in the portable electronic apparatus, and the portable electronic apparatus should be manufactured to be smaller in size and thinner in thickness to enhance portability. In this case, the mounting space of a battery pack in the portable electronic apparatus should be sufficient in order to supply much power to the portable electronic apparatus. When a battery pack having large capacity is used, it is difficult to implement a portable electronic apparatus which is small in size and thin in thickness.

### SUMMARY

One or more embodiments are directed to a portable electronic apparatus, including: a terminal inside which a first battery unit is provided; a grip portion inside which a second battery unit electrically connected to the terminal is provided, the grip portion being positioned at an outside of the terminal; and a controller configured to control power to be supplied from the second battery unit to the terminal rather than power of the first battery unit.

The controller may be positioned inside the terminal.

The portable electronic apparatus may further include a sensing unit configured to sense a remaining capacity of the second battery unit; a first switching unit configured to electrically connect or disconnect between the first battery unit and the terminal; and a second switching unit configured to electrically connect or disconnect between the second battery unit and the terminal. The controller may operate the first and second switching units, based on the value of the remaining capacity of the second battery unit, measured by the sensing unit.

When the remaining capacity of the second battery unit does not exist, the controller may control the first switching unit to electrically connect between the first battery unit and the terminal, and control the second switching unit to electrically disconnect between the second battery unit and the terminal.

The grip portion may be rotatable with respect to the terminal.

The grip portion may be rotatable between a first position parallel to the terminal and a second position inclined from the terminal.

The grip portion may be provided with a pair of grip portions to be respectively positioned at both opposite sides of the terminal.

The grip portion may be provided with a button, and the terminal may be controlled by the button.

The first and second battery units may include battery packs having different shapes from each other.

The first battery unit may include a pouch-type battery pack, and the second battery unit may include a cylindrical battery pack.

The portable electronic apparatus may further include a connecting portion configured to connect between the grip portion and the terminal.

The second battery unit may be electrically connected to the terminal through the connecting portion.

One side of the connecting portion may be connected to the grip portion, and the other side of the connecting portion may be connected to the terminal. The grip portion may be rotatable with respect to the one side of the connecting portion, and the other side of the connecting portion may be rotatable with respect to the terminal.

The grip portion may be attachable/detachable to/from the terminal.

### BRIEF DESCRIPTION OF THE DRAWINGS

Features will become apparent to those of skill in the art by describing in detail exemplary embodiments with reference to the attached drawings in which:

FIG. 1 illustrates a perspective view of a portable electronic apparatus according to an embodiment.

FIG. 2 illustrates a schematic view illustrating an electrical connection relationship of the portable electronic apparatus shown in FIG. 1.

FIG. 3 illustrates a perspective view of the portable electronic apparatus shown in FIG. 1 in which a grip portion of the portable electronic apparatus is rotated.

FIG. 4 illustrates a perspective view of a portable electronic apparatus according to another embodiment.

FIG. 5 illustrates a perspective view of a portable electronic apparatus according to still another embodiment.

FIGS. 6 and 7 illustrate perspective views of the portable electronic apparatus shown in FIG. 5, illustrating a state in which a grip portion of the portable electronic apparatus is rotated.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Also, when a layer or element is referred to as being “between” another layer or substrate, it can be directly between the other layer or substrate, or intervening layers may also be present. Also, when an element is referred to as being “connected to” another element, it can be directly connected to the another element or be indirectly connected to the another element with one or more intervening elements interposed therebetween. Like reference numerals refer to like elements throughout.

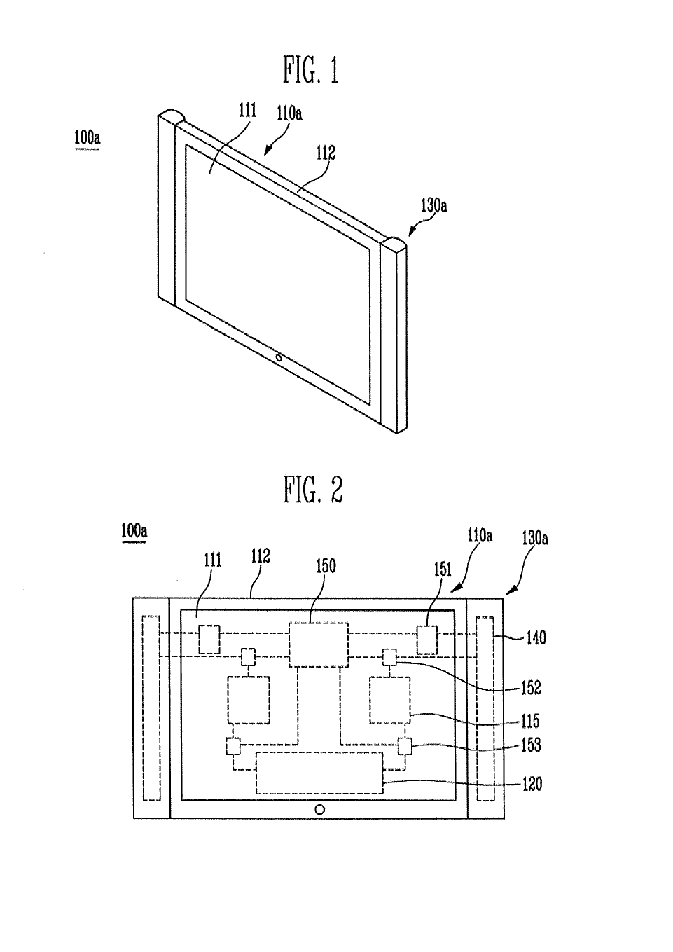

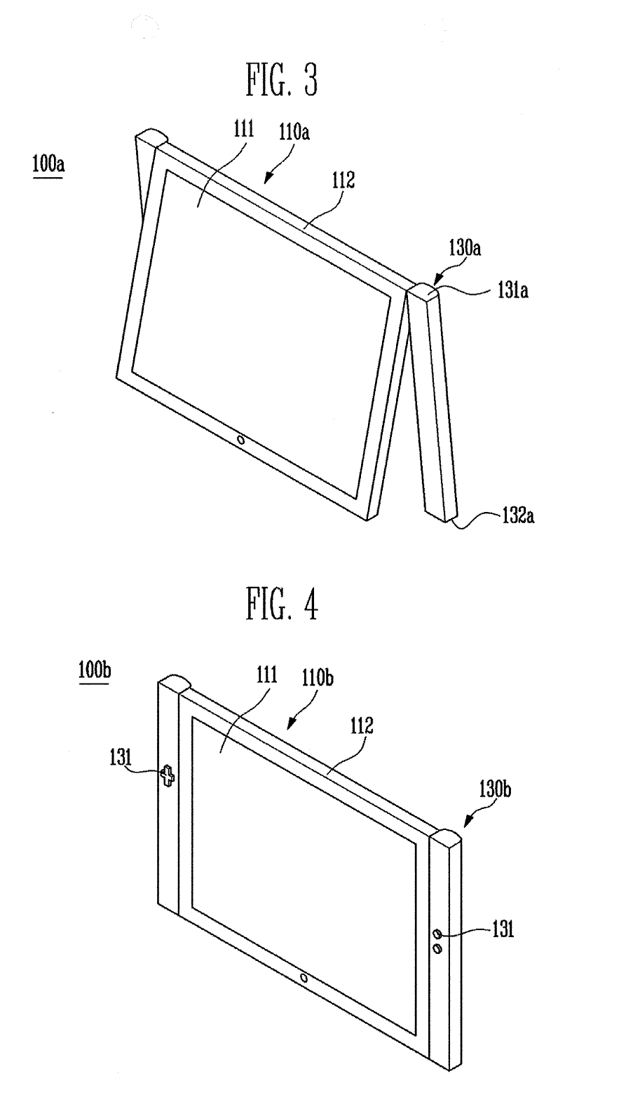

FIG. 1 illustrates a perspective view of a portable electronic apparatus 100a according to an embodiment. FIG. 2 illustrates a schematic view illustrating an electrical connection relationship of the portable electronic apparatus 100a shown in FIG. 1.

As shown in FIGS. 1 and 2, the portable electronic apparatus 100a may include a terminal 110a provided with a first battery unit 120, a grip portion 130a provided with a second battery unit 140, the grip portion 130a being positioned outside the terminal 110a, and a controller 150 configured to control power of the first and second battery units 120 and 140. The controller 150 may allow the terminal 110a to first use the power of the second battery unit 140 rather than the power of the first battery unit 120.

The terminal 110a is a portion which becomes, for example, a main body of the portable electronic apparatus 100a, e.g., a smart phone or tablet PC.

The terminal 110a may include, e.g., a display 111 provided with a touch screen, an outer case 112, internal electronic components, and the like. The battery unit 120 may be provided inside the terminal 110a. The first battery unit 120 may be implemented as a battery built in the terminal 110a to be attachable/detachable to/from the terminal 110a or not to be attachable/detachable to/from the terminal 110a. The first battery unit 120 may include a pouch-type battery pack, allowing the first battery unit 120 and, hence, the terminal 110a, to be smaller and thinner than if a prismatic or cylindrical battery pack was used as the first battery unit 120.

The controller 150 may be positioned inside the terminal 110a. The controller 150 is electrically connected to the first and second battery units 120 and 140, to control the first and second battery units 120 and 140. However, the controller 150 is not necessarily positioned inside the terminal 110a. That is, the controller 150 may be positioned in the grip portion 130a.

The grip portion 130a may be positioned outside of the terminal 110a. The grip portion 130a is a member which is available for a handle, an external battery, a terminal stand, etc.

Here, the second battery unit 140 may be provided inside the grip portion 130a. The second battery unit 140 is electrically connected to the terminal 110a, to act as an external battery. In this case, the second battery unit 140 is relatively less influenced by a space, as compared with the first battery unit 120. Hence, the second battery unit 140 may include, for example, a cylindrical battery pack having a shape different from that of the battery pack of the first battery unit 120. Since the terminal 110a according to this embodiment further includes the second battery unit 140 in addition to the first battery unit 120, the second battery unit 140 enables the terminal 110a to be used for a longer period of time than if only the first battery unit 120 was used without increasing the size of the terminal 110a. Accordingly, it is possible to provide a user with convenience and portability.

In order to use the grip portion 130a as a handle of the terminal 110a, the grip portion 130a may have, for example, a finger-shaped groove formed therein. Alternatively, the grip portion 130a may have an anti-slipping projection or pad attached thereto. Alternatively, the grip portion 130a may be made of a material such as rubber. Thus, a user can grip the portable electronic apparatus 100a, using the grip portion 130a, and can operate the terminal 110a in a state in which the user holds the grip portion 130a. Particularly, in the terminal 110a such as a recent smart phone or tablet PC, the bezel area is decreased, and the display 111 is enlarged. Accordingly, the user has difficulty in gripping the terminal 110a without touching the display 111. The portable electronic apparatus 100a according to this embodiment includes the grip portion 130a to be used as a handle, thereby solving such a problem.

The grip portion 130a may be implemented to be attachable/detachable, e.g., completely attached and detached, to/from the terminal 110a, and accordingly, the user can use the terminal 110a by connecting the grip portion 130a to the terminal 110a or can operate only the terminal 110a by separating the grip portion 130 from the terminal 110a, when necessary.

The controller 150 is electrically connected to the first and second battery units 120 and 140, to control the first and second battery units 120 and 140.

Specifically, the controller 150 may control a terminal driving unit 115 requiring power among the components of the terminal 110a to first use the power of the second battery unit 140 rather than the power of the first battery unit 120. After the power of the second battery unit 140 is depleted, the controller 150 may allow the terminal driving unit 115 to use the power of the first battery unit 120. Thus, after the power of the second battery unit 140 is depleted, the user can separate the grip portion 130a from the terminal 110a and then use the terminal 110a with the power of the first battery unit 120. Accordingly, the portability of the terminal 110a can be further improved.

The portable electronic apparatus 100a according to this embodiment may further include a sensing unit 151 and first and second switching units 153 and 152. The sensing unit 151 measures a remaining capacity of the second battery unit 140 and transmits the value of the remaining capacity to the controller 150. The controller 150 receives the value transmitted from the sensing unit 151, to operate the first and second switching units 153 and 152. For example, when the remaining capacity of the second battery unit 140, measured by the sensing unit 151, is 0 or approaches 0, the controller 150 operates the second switching unit 152 to block the electrical connection between the second battery unit 140 and the terminal driving unit 115, and operates the first switching unit 153 to electrically connect between the first battery unit 120 and the terminal driving unit 115. Accordingly, the terminal 110a can be operated with the power of the first battery unit 120. In a case where the remaining capacity of the second battery unit 140, measured by the sensing unit 151, exists and is larger than 0, the controller 150 continuously opens the second switching unit 152 to maintain the electrical connection, and continuously closes the first switching unit 153 to maintain the state in which the electrical connection is blocked.

Although it has been illustrated in FIG. 2 that the sensing unit 151 and the second switching unit 152 are positioned inside the terminal 110a, the sensing unit 151 and the second switching unit 152 may be positioned in the grip portion 130a.

FIG. 3 illustrates a perspective view of the portable electronic apparatus 100a shown in FIG. 1, illustrating a state in which the grip portion 130a of the portable electronic apparatus 100a is rotated. Hereinafter, the rotation of the grip portion 130 will be described with reference to FIG. 3.

The grip portion 130a of the portable electronic apparatus 100a according to this embodiment may be rotatable with respect to the terminal 110a. Specifically, the grip portion 130a may be rotatable with respect to the terminal 110a between a first position (position of FIG. 1) positioned in parallel to the terminal 110a, e.g., along a width of the terminal 110a, and a second position (position of FIG. 3) inclined from the terminal 110a. In the particular embodiment illustrated in FIG. 3, first and second ends 131a, 132a of the grip portion 130a may be releasably secured to an edge of opposite sides of the terminal 110a along a length of the terminal 110a. Thus, the terminal 110a may be stably held as in FIG. 1, may be adjustably inclined by releasing either of the first or second ends as in FIG. 3, or may have the grip portions 130a completely removed therefrom by releasing both ends. Alternatively or additionally, the grip portion 130a could be affixed to an edge of opposite sides of the terminal 110a along a width of the terminal 110a such that the grip portion 130a extends parallel to a length of the terminal 110a. The grip portion 130a may be used as a handle of the portable electronic apparatus 100a at the first position shown in FIG. 1. If the user holds the grip portion 130a for a long period of time in a state in which the terminal 110a is continuously positioned inclined for the purpose of watching moving pictures, fatigue may be imposed on the user's hands. Therefore, the user may stand the terminal 110a on the ground or the like by rotating the grip portion 130a to the second position shown in FIG. 3. Accordingly, the user can conveniently use the terminal 110a.

When the grip portion 130a is positioned only at one side of the terminal 110a, it may be difficult to support the terminal 110a using only one grip portion 130a. Therefore, the grip portion 130a may include a pair of grip portions to be respectively positioned at opposite sides of the terminal 110a, thereby stably supporting the terminal 110a on the ground or the like. When the grip portion 130a includes the pair of grip portions, the second battery unit 140 may also include a pair of second battery units respectively provided in the pair of grip portions. Accordingly, the use time of the portable electronic apparatus 100a can be further increased.

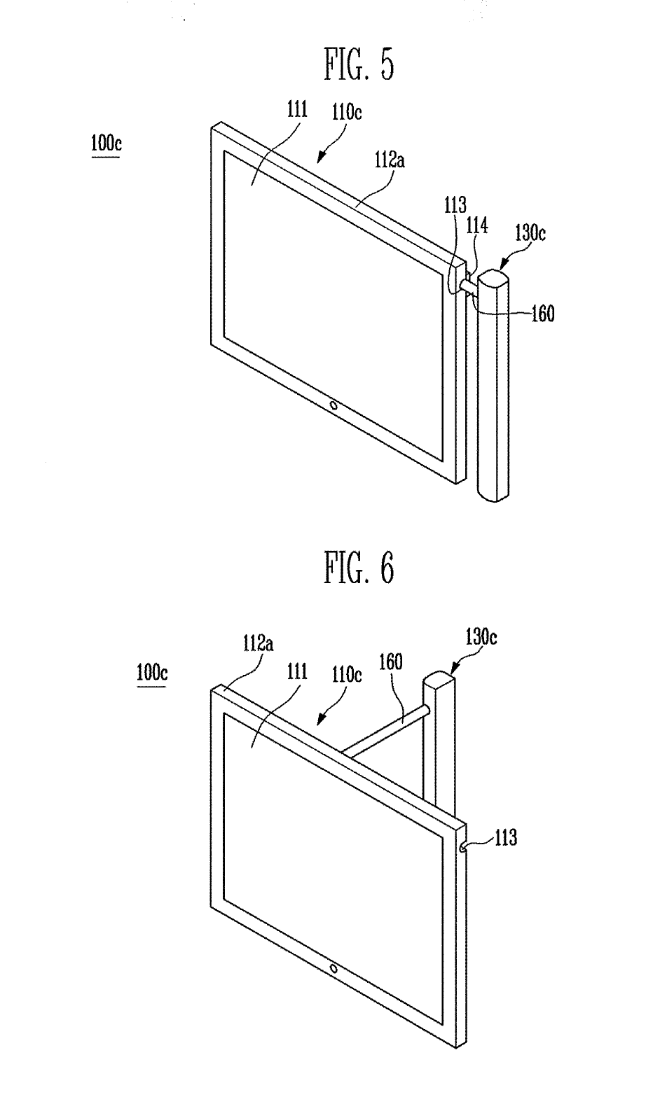

FIG. 4 illustrates a perspective view of a portable electronic apparatus 100b according to another embodiment. Hereinafter, the portable electronic apparatus 100b according to this embodiment will be described with reference to FIG. 4. Here, components identical or corresponding to those of the aforementioned embodiment are designated by like reference numerals, and their detailed descriptions will be omitted to avoid redundancy.

As shown in FIG. 4, the portable electronic apparatus 100b according to this embodiment includes a terminal 110b, a grip portion 130b, and the controller 150 (shown in FIG. 2), and the grip portion 130b may be provided with a button 131. In this case, the terminal 110b may be controlled by the button 131, and the button 131 may be configured to have the configuration of a joypad, so that the grip portion 130b can be used as a joypad for games. Particularly, when the grip portion 130b is provided at both sides of the terminal 110b, a user may enjoy games while operating the buttons 131 of the grip portions 130b in a state in which the user holds the grip portions 130b respectively with both hands.

Additionally, in recent smart phone or tablet PC, holding the terminal 110b may be difficult due to a small bezel area in the operation of a camera, and it is difficult to touch a camera photographing display portion displayed on the display 111. However, the portable electronic apparatus 100b may be implemented so that the user can operate the camera through the button 131 while holding the grip portion 130b. Accordingly, the user can conveniently use a camera function.

In this case, a control signal of the button 131 may be transmitted to the terminal 110b through the controller 150.

FIG. 5 illustrates a perspective view of a portable electronic apparatus 100c according to still another embodiment. Hereinafter, the portable electronic apparatus 100c according to this embodiment will be described with reference to FIG. 5. Here, components identical or corresponding to those of the aforementioned embodiment are designated by like reference numerals, and their detailed descriptions will be omitted to avoid redundancy.

As shown in FIG. 5, the portable electronic apparatus 100c according to this embodiment may include a terminal 110c, a grip portion 130c, the controller 150 (shown in FIG. 2), an outer case 112a including a groove portion 113 therein, and a connecting portion 160 configured to connect between the grip portion 130c and the terminal 110c. Here, a first end of the connecting portion 160 may be releasably connected to the grip portion 130c and a second end of the connecting portion 160 may be connected to the terminal 110c, e.g., an edge along the width of the terminal 110c. Thus, the second battery unit 140 positioned in the grip portion 130c can be electrically connected to the terminal 110c through the connecting portion 160, e.g., through a conducting wire provided inside the connecting portion 160

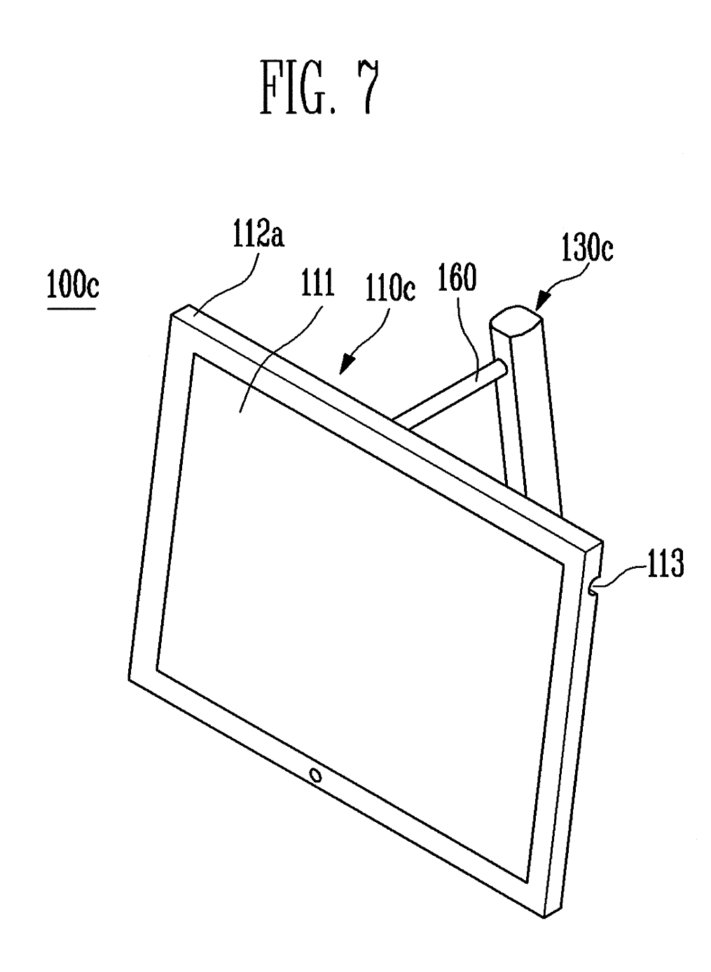

FIGS. 6 and 7 illustrate perspective views of the portable electronic apparatus 100c shown in FIG. 5, illustrating a state in which a grip portion of the portable electronic apparatus 100c is rotated. Hereinafter, the rotation of the grip portion 130c and the connecting portion 160 according to this embodiment will be described with reference to FIGS. 6 and 7.

In a case where the user stands the terminal 110a by rotating the grip portion 130a as described in the aforementioned embodiment, the grip portion 130a is provided with a pair of grip portions, thereby stably supporting the terminal 110a. However, when much battery capacity is not required or when the portability is important, i.e., when the user desires a case where only one grip portion 130a exists, there may occur a case where the grip portion 130a is unnecessarily implemented with a pair of grip portions.

In this embodiment, in order to solve such a problem, the terminal 110c can be easily held even when only one grip portion 130c exists. Specifically, unlike the aforementioned embodiment, the portable electronic apparatus 100c further includes the connecting portion 160. The connecting portion 160 may not be connected to a side of the terminal 110c, but may be connected to the center of a rear side opposite to a front side at which the display 111 is positioned. In particular, the connecting portion 160 may be secured in the parallel position illustrated in FIG. 5 by a fastener 114 securing the connecting portion 160 in the groove portion 113 in a side of the outer case 112a along the width of the terminal 110c. In a case where the user desires to stand the terminal 110c while using the grip portion 130c as a handle at a first position (position of FIG. 5) where the connecting portion 160 and the grip portion 130c are parallel to the terminal 110c, the following procedure may be performed.

First, the second side of the connecting portion 160 may be rotated with respect to the terminal 110c as shown in FIG. 6. In this case, the connecting portion 160 may be rotated by separating the connecting portion 160 placed in the groove portion 113 of the terminal 110c at the position shown in FIG. 5 from the fastener 114 of the terminal 110c. Here, the position of the connecting portion 160 may form an almost right angle to the terminal 110c.

Next, the grip portion 130c may be rotated from the first side of the connecting portion 160 as shown in FIG. 7. In this case, the rotational direction of the grip portion 130c may be almost vertical, as compared with that of the other side of the connecting portion 160. The grip portion 130c may form a shape inclined with respect to the connecting portion 160 at a second position shown in FIG. 7. The user can easily stand the terminal 110c with only one grip portion 130c at the second position shown in FIG. 7, and accordingly, it is possible to provide a user with convenience and portability. Although it has been described in this embodiment that the user first rotates the connecting portion 160 and then rotates the grip portion 130c, embodiments are not limited thereto. That is, the user may rotate the grip portion 130c and then rotate the connecting portion 160. Alternatively, the user may simultaneously rotate the grip portion 130c and the connecting portion 160. The second side of the connecting portion 160 may be implemented to be rotatable in a direction vertical to the terminal 110c as shown in FIG. 6, i.e., in a direction identical to the rotational direction of the grip portion 130c. In this case, the user can stand the terminal 110c at various angles.

Alternatively, the outer case 112a may have a groove portion 113 for receiving the connecting portion 160 that is positioned along a length of the terminal such that the grip portion 130c extends along the length of the terminal.

Embodiments provide a portable electronic apparatus which can be implemented to be small and thin while allowing sufficient power to be supplied thereto.

According to the portable electronic apparatus of one or more embodiments, the controller first supplies the power of the second battery unit to the terminal rather than the power of the first battery unit, so that the terminal can be used for a long period of time. Further, use of such a second battery unit, the mounting space of a battery pack in the terminal is minimized, so that it is possible to implement the terminal to be small in size and thin in thickness.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A portable electronic apparatus, comprising:
a terminal having a first battery unit therein;
a grip portion having a second battery unit electrically connected to the terminal, the grip portion being positioned outside of the terminal; and
a controller configured to control the second battery unit to supply power to the terminal before the first battery unit supplies power to the terminal.

2. The portable electronic apparatus as claimed in claim 1, wherein the controller is positioned inside the terminal.

3. The portable electronic apparatus as claimed in claim 1, further comprising:
a sensing unit configured to sense a remaining capacity of the second battery unit;
a first switching unit configured to electrically connect or disconnect the first battery unit and the terminal; and
a second switching unit configured to electrically connect or disconnect the second battery unit and the terminal,
wherein the controller operates the first and second switching units, based on the remaining capacity of the second battery unit, measured by the sensing unit.

4. The portable electronic apparatus as claimed in claim 3, wherein, when the remaining capacity of the second battery unit falls below a certain level, the controller controls the first switching unit to electrically connect the first battery unit and the terminal, and controls the second switching unit to electrically disconnect the second battery unit and the terminal.

5. The portable electronic apparatus as claimed in claim 1, wherein the grip portion is rotatable with respect to the terminal.

6. The portable electronic apparatus as claimed in claim 1, wherein the grip portion is rotatable between a first position parallel to the terminal and a second position inclined from the terminal.

7. The portable electronic apparatus as claimed in claim 1, wherein the grip portion includes a pair of grip portions to be respectively positioned at opposite sides of the terminal.

8. The portable electronic apparatus as claimed in claim 7, wherein each of the pair of grip portions is rotatable between a first position parallel to the terminal and a second position inclined from the terminal.

9. The portable electronic apparatus as claimed in claim 1, wherein the grip portion includes a button that controls the terminal.

10. The portable electronic apparatus as claimed in claim 1, wherein the first and second battery units include battery packs having different shapes from each other.

11. The portable electronic apparatus as claimed in claim 10, wherein the first battery unit includes a pouch-type battery pack and the second battery unit includes a cylindrical battery pack.

12. The portable electronic apparatus as claimed in claim 1, further comprising a connecting portion configured to connect the grip portion and the terminal.

13. The portable electronic apparatus as claimed in claim 12, wherein the second battery unit is electrically connected to the terminal through the connecting portion.

14. The portable electronic apparatus as claimed in claim 12, wherein:
a first side of the connecting portion is connected to the grip portion and a second side of the connecting portion is connected to the terminal, and
the grip portion is rotatable with respect to the first side of the connecting portion and the second side of the connecting portion is rotatable with respect to the terminal.

15. The portable electronic apparatus as claimed in claim 12, wherein the grip portion is attachable/detachable to/from the connecting portion.

16. The portable electronic apparatus as claimed in claim 1, wherein the grip portion is attachable/detachable to/from the terminal.
